(19) United States
(12) Patent Application Publication
(10) Pub. No.: US 2003/0137918 A1
(43) Pub. Date: Jul. 24, 2003

(54) Method for recording a three dimensional(3D) audio signal on CD or DVD disks

(76) Inventor: Youlian Stefanov Dimitrov, Brooklyn, NY (US)

Correspondence Address: Youlian Dimitrov, Suite #152, 2106 Bath Ave. Flr. 1, Brooklyn, NY, 11214-4908, US

(21) Appl. No.: 10/053,942

(22) Filed: Jan. 24, 2002

(51) Int. Cl. G11B 7/00

(52) U.S. Cl. 369/103

(57) ABSTRACT

A audio data from CD (Compact Disk) or DVD (Digital Versatile Disk) is recorded (prerecorded) using a three dimensional (3D) method. The CD or DVD Disks can be used as read only discs after the transformation process into the 3D method.

### BACKGROUND OF THE INVENTION

1. Field of the Invention

This invention relates to a new three dimensional audio digital signal recording and reproducing devices. Specifically, this invention is a new unique method for recording or prerecording a CD or DVD audio disks.

Therefore, using the 3D method which optical audio disks (CD or DVD) have been used to read audio data the sound signal has been transformed using a digital music recording device, into a three times better signal of the existing now at the music industry market audio CD, DVD's read-only disks.

### SUMMARY OF THE INVENTION

An objective of the present invention is to provide a three dimensional sound which can be readed from regular CD, CD-ROM, DVD, etc.

This new unique method is a revolutionary progress in a music industry recording business. It will open a new field of the way look and listen optical disks. To achieve the objective of the present invention the three dimensional method can be used with an audio recording device in which can be included and computer.

1. I claim that I am the first person who develop the three dimensional method (3D), which I used for creating an audio CD or DVD disks that can be recorded or prerecorded into a 3D CD or 3D DVD read-only disks and these disks can be used in the the music market.
